(19) United States
(12) Patent Application Publication
(10) Pub. No.: US 2010/0189243 A1
(43) Pub. Date: Jul. 29, 2010

(54) ENHANCED ANNOUNCEMENT OF CONFERENCE CALL PARTICIPANTS

(76) Inventors: Steven M. Miller, Cary, NC (US); Jana H. Jenkins, Raleigh, NC (US); Lloyd W. Allen, JR., Cary, NC (US)

Correspondence Address: MOORE & VAN ALLEN, PLLC For IBM, P.O. Box 13706, Research Triangle Park, NC, 27709, US

(21) Appl. No.: 12/360,251

(22) Filed: Jan. 27, 2009

(51) Int. Cl. H04M 3/42

(52) U.S. Cl. 379/202.01

(57) ABSTRACT

Enhanced announcement of conference call participants that may include allowing a party to join a teleconference call, identifying a class of the party that has joined the teleconference call, and generating a notification in the teleconference call related to the class of the party that has joined the teleconference call. A processing device may include a network interface, at least one second interface configured to establish a connection between at least three telephones, and a processor configured to allow a party to join a teleconference call, identify a class of the party that has joined the teleconference call, and generate a notification in the teleconference call related to the class of the party that has joined the teleconference call. The notification may be a tone, a signal, a name, or other type notification.

The present application is related to the following applications that each have the same inventors and assignee and where the serial number is not yet known: “Contacting A Person Outside of a Teleconference Without Leaving the Teleconference”, Atty Docket 014682-000098; “Accessing Details of Teleconference Call Invitees”, Atty Docket 014682-000099; “Providing Multilevel Conference Call Participants”, Atty Docket 014682-000100; “Rules-Based Teleconferencing”, Atty Docket 014682-000103.

### BACKGROUND OF THE INVENTION

The present invention is related to conference calls, and more specifically to enhanced announcement of conference call participants.

Conference calls, or multi-party calls provided though a conference bridge service have become a common means of conducting business meetings. Invited parties are given an access telephone number and usually a passcode or passphrase to authenticate to the call service and be joined into the conference call. Passcodes may not be required, permitting unauthenticated access to the conference. It is also common to have one passcode for the meeting leader or moderator and another passcode for meeting participants, and thus a shared access code. Also, each party may have unique access codes, providing higher security and better means of distinguishing or identifying calling parties.

### BRIEF SUMMARY OF THE INVENTION

According to one aspect of the present invention, a method for enhanced announcement of conference call participants that includes allowing a party to join a teleconference call, identifying a class of the party that has joined the teleconference call, and generating a notification in the teleconference call related to the class of the party that has joined the teleconference call.

According to another aspect of the present invention, a processing device that includes a network interface, at least one second interface configured to establish a connection between at least three telephones, and a processor configured to allow a party to join a teleconference call, identify a class of the party that has joined the teleconference call, and generate a notification in the teleconference call related to the class of the party that has joined the teleconference call.

According to a further aspect of the present invention, a computer program product comprising a computer useable medium having computer useable program code embodied therewith, the computer useable program code comprising computer useable program code configured to allow a party to join a teleconference call, computer useable program code configured to identify a class of the party that has joined the teleconference call, and computer useable program code configured to generate a notification in the teleconference call related to the class of the party that has joined the teleconference call.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flowchart of a process for enhanced announcement of conference call participants according to an exemplary embodiment of the present invention;

FIG. 2 is a flowchart of a process for enhanced announcement of conference call participants according to another exemplary embodiment of the present invention;

FIG. 3 is a flowchart of a process for enhanced announcement of teleconference call participants according to a still further exemplary embodiment of the present invention; and

FIG. 4 is a diagram of a system or enhanced announcement of teleconference call participants according to an exemplary embodiment of the present invention.

### DETAILED DESCRIPTION OF THE INVENTION

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention further enhance the ability to define multiple levels of invitees to a conference call, similar to an email or electronic calendar invitation. Some conference call invitees may be required or expected to attend, while other invitees may be merely invited but neither expected or required. Additionally, there may be other parties that are authorized but not enumerated, e.g., parties that either were not specifically invited by the conference leader, but were passed the conference details from an invitee. This last group may be allowed access with a shared passcode, or not be required to provide any authentication at all. Caller-ID information may be available to help identify callers. The following example helps illustrate a meeting invention according to some embodiments of the present invention.

### EXAMPLE

Meeting invitation: Nov. 30, 2007 8:00-9:00 AM EST
Phone access: 800-555-1200
Subject: product discussion
Leader: Bob Jones, passcode=12345678
Required participants: Cindy Ames, passcode=543200
Tony Soluto, passcode=864219
Billy Biggs, passcode=644478
Optional participants: Troy Dunnit, passcode=0004444
Suzy Whosit, passcode=558833
Open access: passcode=222278

Briefly, an originator of the teleconference call or chairperson may decide to proceed with the teleconference call without the missing “required” invitee(s) for various reasons. According to embodiments of the present invention, depending on what type of participant joins, a unique and distinguishable notification such as a tone or a signal may be used to announce a new party joining. To illustrate embodiments of the present invention, a tone will be used as the notification, however, embodiments of the present invention are not limited to use of a tone as any type of notification is within the scope of the present invention. A meeting leader may have a specific “leader” tone, required participants may have another tone, optional participants may have yet another tone, and other “open access” parties have their own unique tone when joining the teleconference call. Some embodiments of the present invention may allow for unique tones for each participant, instead of by groups of participants. Additionally, according to embodiments of the present invention announcements may be enabled or disabled for each possible group or participant defined. Control for these functions may be easily controlled through known methods, such as online DTMF menus, voice control, etc.

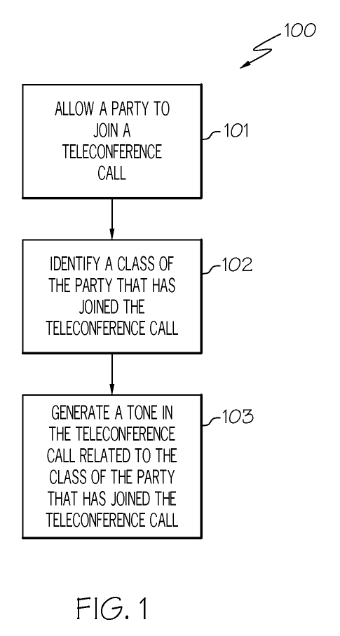

FIG. 1 shows a flowchart of a process for enhanced announcement of conference call participants according to an exemplary embodiment of the present invention. In the process 100, in block 101, a party may be allowed to join a teleconference call. In block 102, a class of the party that has joined the teleconference call may be identified. In block 103, a tone, a signal, or other type notification, may be generated in the teleconference call related to the class of the party that has joined the teleconference call.

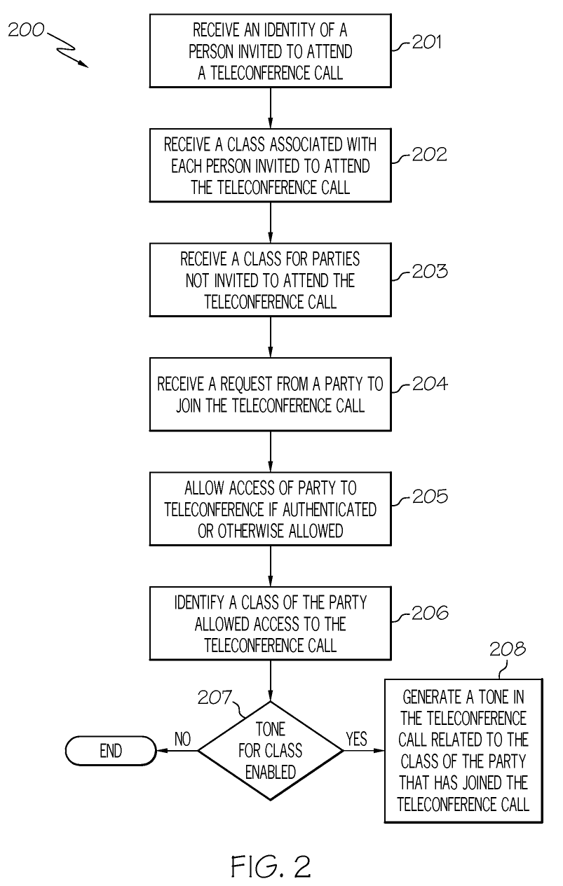

FIG. 2 shows a flowchart of a process for enhanced announcement of conference call participants according to another exemplary embodiment of the present invention. In the process 200, in block 201, an identity of a person invited to attend a teleconference call may be received. In block 202, a class associated with each person invited to attend the teleconference call may be received. In block 203, a class for parties not invited to attend the conference call may be received. In block 204, a request from a party to join the teleconference call may be received. In block 205, access of the party to the teleconference call may be allowed if authenticated or otherwise allowed. For example, the teleconference call be setup such that parties may be allowed to join the teleconference call with a valid passcode and/or may be allowed to join the teleconference call without any passcode. In block 206, a class of the party allowed access to the teleconference call may be identified. In block 207, it may be determined whether generating a tone for a class of a party entering the teleconference call has been enabled and if not, the process ends. If generation of a tone when a party of a particular class has joined the teleconference call is enabled, then in block 208, a tone (or any other type notification) may be generated in the teleconference call related to the class of the party that has just joined the teleconference call.

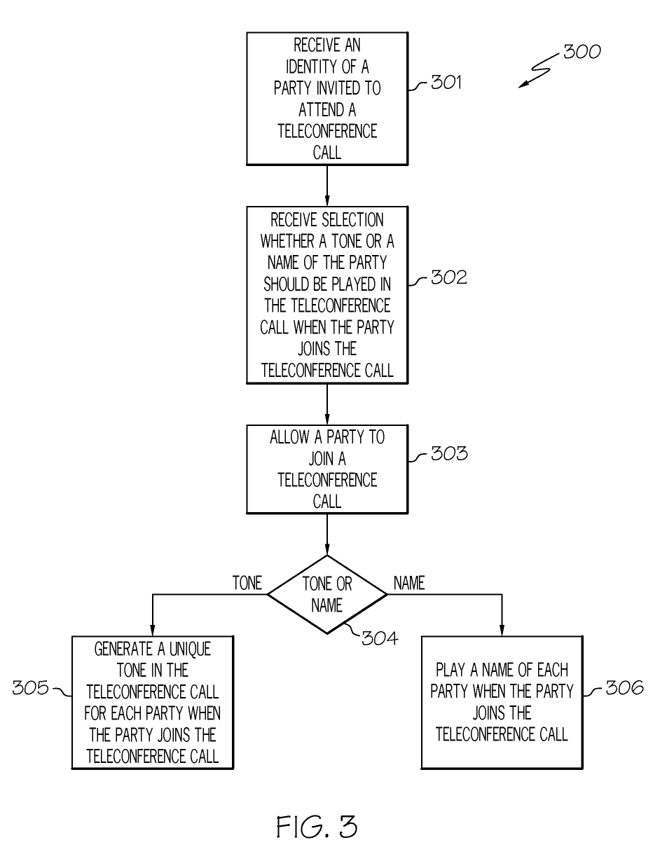

FIG. 3 shows a flowchart of a process for enhanced announcement of teleconference call participants according to a still further exemplary embodiment of the present invention. In the process 300, in block 301, an identity of a party invited to attend a teleconference call may be received. In block 302, selection of whether a tone or a name of the party should be played in the teleconference call when the party joins the teleconference call may be received. In block 303, a party may be allowed to join a teleconference call. In block 304, it may be determined whether a tone generation or name is enabled. If tone has been selected, then in block 305, a unique tone may be generated in the teleconference call for each party when the party joins the teleconference call. If name has been selected, then in block 306, a name of each party may be played when the party joins the teleconference call. The selection of a tone or a name being played (or nothing at all) may be selected when the conference call is setup.

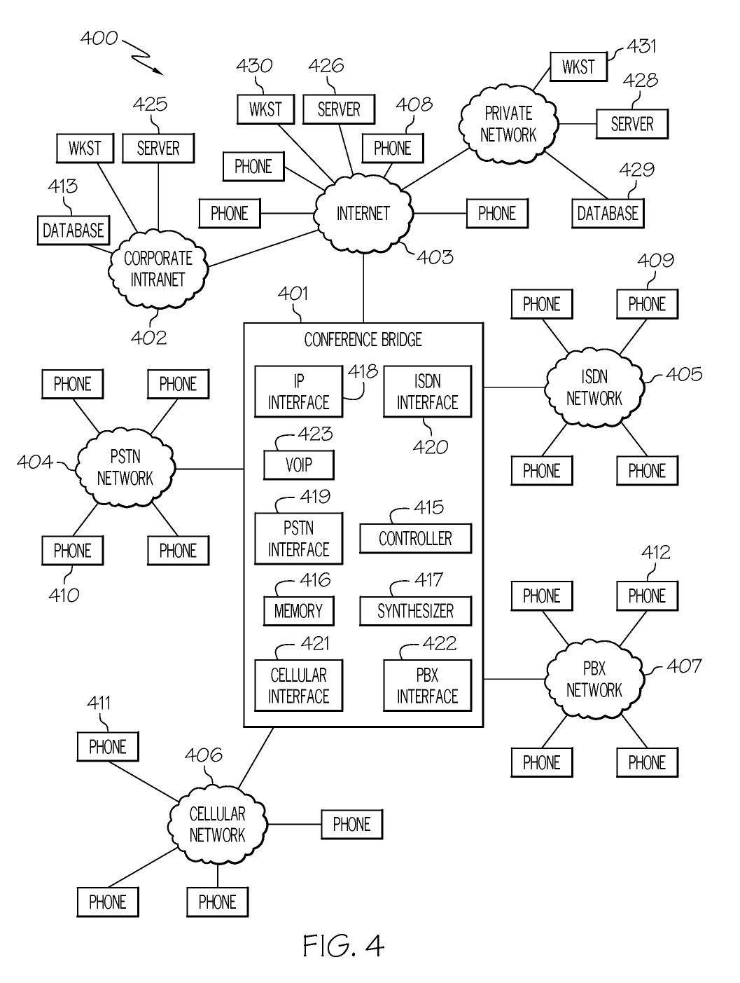

FIG. 4 shows a diagram of a system or enhanced announcement of teleconference call participants according to an exemplary embodiment of the present invention. The system 400 may include a processing device 401 that may be interconnected to one or more networks or other resources. The processing device 401 may be a call system, a conference bridge, or any similar type device. To illustrate embodiments of the present invention the processing device 401 will be referred to as a call system. The call system 401 may be interconnected to the Internet 403 that may be interconnected to one or more telephones 408, a corporate Intranet 402 that may have access to a database 413 and a server 425, a public switched telephone network (PSTN) 404 that may be connected to one or more telephones 410, a cellular network 406 that may be interconnected to one or more telephones 411, a Private Branch Exchange (PBX) network 407 that may be interconnected to one or more telephones 412, an Integrated Services Digital Network (ISDN) 405 that may be interconnected to one or more telephones 409, etc. The Internet 403 may also allow connection to one or more servers 426, one or more workstations 430, and a private network 427 that may be connected to one or more servers 428, one or more workstations 431, and a database 429. The call system 401 may include an Internet Protocol (IP) interface 418, voice over IP (VOIP) processing 423, a PSTN interface 419, an ISDN interface 420, a cellular interface 421, a PBX interface 422, a synthesizer 417, memory 416, and a controller or processor 415 that controls processing and all of the interfaces.

The call system 401 may setup a teleconference call with one or more telephones from any of the networks 402-407. Further, the call system 401 may allow a party to join a teleconference call, identify a class of the party that has joined the teleconference call, and generate a notification (e.g., tone, signal, name, etc.) in the teleconference call related to the class of the party that has joined the teleconference call. A party may be allowed to join the teleconference call based on the call system receiving a valid passcode, or a party may be allowed to join the teleconference call without receiving a passcode.

A class may be a class defining parties that are required to attend the teleconference call, a class defining parties that are invited to attend the teleconference call but not required, a class defining parties that were not originally invited to the teleconference call but were invited by a party that was invited to the teleconference call, parties that are authorized but not enumerated, e.g., parties which were originally invited but may be using a shared passcode and thus not specifically distinguishable from one another, etc. Parties in different classes may each have a unique passcode allowing access to the teleconference call. Further, parties in a class may all have a shared passcode allowing access to the teleconference call.

A call system may generate a first tone when a party in the one class has joined the teleconference call, a second tone when a party in a different class has joined the teleconference call, and a third tone when a party in another different class has joined the teleconference call, the first tone, the second tone and the third tone each being unique. A unique tone may also be generated in the teleconference call when a meeting leader has joined the teleconference call and/or a unique tone generated in the teleconference call for each party that has joined the teleconference call. A name of a party may be generated in the teleconference call for each party that has joined the teleconference call. Moreover generation of a tone, signal, name or other notification in the teleconference call related to a particular class of a party that has joined the teleconference call may be disabled while generating a tone in the teleconference call for each party of a different class.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for enhanced announcement of teleconference call participants comprising:
allowing a party to join a teleconference call;
identifying a class of the party that has joined the teleconference call; and
generating a notification in the teleconference call related to the class of the party that has joined the teleconference call.

2. The method according to claim 1, further comprising receiving a valid passcode and allowing the party to join the teleconference call based on the valid passcode.

3. The method according to claim 1, wherein the notification comprises one of a tone, a signal, and a name.

4. The method according to claim 1, wherein the class comprises one of a first class defining specific parties that are required to attend the teleconference call, a second class defining specific parties that are invited to attend the teleconference call but not required, and a third class defining parties that are authorized but not enumerated to the teleconference call.

5. The method according to claim 4, wherein the parties in the first class and the parties in the second class each have a unique passcode allowing access to the teleconference call.

6. The method according to claim 4, wherein the parties in the third class all have a shared passcode allowing access to the teleconference call.

7. The method according to claim 4, wherein the parties in the third class are not required to provide a passcode for access to the teleconference call.

8. The method according to claim 4, wherein a first notification is generated when a party in the first class has joined the teleconference call, a second notification is generated when a party in the second class has joined the teleconference call, and a third notification is generated when a party in the third class has joined the teleconference call, the first notification, the second notification and the third notification each being unique.

9. The method according to claim 1, further comprising generating a unique notification in the teleconference call when a meeting leader has joined the teleconference call.

10. The method according to claim 1, further comprising disabling the generation of a notification in the teleconference call related to the class of the party that has joined the teleconference call.

11. The method according to claim 10, further comprising generating one of a unique notification in the teleconference call for each party that has joined the teleconference call and a name of a party in the teleconference call for each party that has joined the teleconference call.

12. The method according to claim 1, further comprising disabling the generation of a notification in the teleconference call for each party of one class and enabling the generation of a notification in the teleconference call for each party of another class.

13. A processing device comprising:
a network interface;
at least one second interface configured to establish a connection between at least three telephones; and
a processor configured to allow a party to join a teleconference call, identify a class of the party that has joined the teleconference call, and generate a notification in the teleconference call related to the class of the party that has joined the teleconference call.

14. The processing device according to claim 13, wherein the processing device comprises a conference bridge.

15. The processing device according to claim 13, wherein the at least one second interface comprises a private branch exchange (PBX) interface.

16. The processing device according to claim 13, wherein the at least one second interface comprises a public switched telephone network (PSTN) interface.

17. The processing device according to claim 13, wherein the at least one second interface comprises a wireless telephone network interface.

18. The processing device according to claim 13, wherein the at least one second interface comprises a Voice over Internet Protocol (VOIP) interface.

19. A computer program product comprising a computer useable medium having computer useable program code embodied therewith, the computer useable program code comprising:
computer useable program code configured to allow a party to join a teleconference call;
computer useable program code configured to identify a class of the party that has joined the teleconference call; and
computer useable program code configured to generate a notification in the teleconference call related to the class of the party that has joined the teleconference call.

20. The computer program product according to claim 19, wherein the class comprises one of a first class defining parties that are required to attend the teleconference call, a second class defining parties that are invited to attend the teleconference call but not required, and a third class defining parties that are authorized but not enumerated to the teleconference call.
